(19) United States
(12) Patent Application Publication
(10) Pub. No.: US 2023/0155135 A1
(43) Pub. Date: May 18, 2023

(54) GRAPHENE-PATCHED YOLK-SHELL ANODES AND METHODS OF PRODUCING THE SAME

(71) Applicant: NanoXplore Inc., Montreal (CA)

(72) Inventors: Nima MOGHIMIAN, Saint Laurent (CA); Soroush NAZARPOUR, Saint Laurent (CA)

(21) Appl. No.: 17/988,502

(22) Filed: Nov. 16, 2022

Related U.S. Application Data
(60) Provisional application No. 63/280,239, filed on Nov. 17, 2021.

(51) Int. Cl. H01M 4/66; H01M 4/04; H01M 4/134; H01M 4/1395; H01M 4/38; H01M 4/76

(52) U.S. Cl. CPC H01M 4/663; H01M 4/0428; H01M 4/0492; H01M 4/134; H01M 4/1395; H01M 4/386; H01M 4/76; H01M 2004/027

(57) ABSTRACT

Embodiments described herein relate to electrodes containing yolk-sell electroactive materials. In some aspects, an anode can include a carbon shell having an outer surface and an inner volume, the carbon shell including a plurality of pinholes on the outer surface. The anode particle is disposed in the inner volume of the carbon shell, such that a portion of the inner volume includes a void space. The anode further includes a plurality of graphene flakes disposed on the outer surface of the carbon shell, the plurality of graphene flakes covering at least a portion of the pinholes. In some embodiments, at least about 50% of the inner volume of the carbon shell can include void space. In some embodiments, the plurality of graphene flakes can cover at least about 90% of the pinholes.

### CROSS-REFERENCE TO RELATED APPLICATIONS

This application claims priority to and the benefit of U.S. Provisional Patent Application No. 63/280,239, filed Nov. 17, 2021, titled, “Graphene-Patched Yolk-Shell Anodes and Methods of Producing the Same,” the disclosure of which is hereby incorporated by reference in its entirety.

### TECHNICAL FIELD

Embodiments described herein relate to anodes containing yolk-shell electroactive materials and methods of producing the same.

### BACKGROUND

Thermodynamic and kinetic properties of electrodes and batteries are important indicators of electrode and battery quality. Material utilization and efficiency of charge and discharge are related to the battery kinetics. The excessive formation of solid electrolyte interphase layers (SEI) on electrode surfaces can lead to performance degradation of the battery. SEIs form from the electrochemical reduction of the electrolyte and can affect the cycle stability of the battery. A larger or thicker SEI leads to a greater amount of irreversible capacity loss. By minimizing direct contact between the active material and the electrolyte, SEI thickness and the irreversible capacity loss from the SEI can be reduced.

### SUMMARY

Embodiments described herein relate to electrodes containing yolk-shell electroactive materials. In some aspects, an anode can include a carbon shell having an outer surface and an inner volume, the carbon shell including a plurality of pinholes on the outer surface. The anode particle is disposed in the inner volume of the carbon shell, such that a portion of the inner volume includes a void space. The anode further includes a plurality of graphene flakes disposed on the outer surface of the carbon shell covering at least a portion of the pinholes. In some embodiments, at least about 50% of the inner volume of the carbon shell can include void space. In some embodiments, the plurality of graphene flakes can cover at least about 90% of the pinholes. In some embodiments, the plurality of graphene flakes can have a thickness of less than about 10 graphene layers. In some embodiments, the anode particles can include silicon. In some embodiments, the silicon can be lithiated. In some embodiments, the carbon shell can include an amorphous carbon shell.

### BRIEF DESCRIPTION OF THE DRAWINGS

FIG. 1 shows formation of SEI layers on an anode containing yolk-shell electroactive materials.

FIG. 2 is a block diagram of an anode containing graphene-patched yolk-shell electroactive materials, according to an embodiment.

FIG. 3 is an illustration of an anode containing graphene-patched yolk-shell electroactive materials, according to an embodiment.

FIG. 4 is a block diagram of a method of producing an anode containing graphene-patched yolk-shell electroactive materials, according to an embodiment.

FIGS. 5A-5E illustrate a method of producing a graphene-patched yolk-shell, according to an embodiment.

### DETAILED DESCRIPTION

Embodiments described herein relate to electrodes containing yolk-shell structures (e.g., yolk-shell anodes). Anodes can include a silicon particle in a carbon shell with a void in the shell. In some embodiments, the silicon particle can be lithiated. In some embodiments, the shell can be composed of amorphous carbon. Amorphous carbon is a self-supporting scaffold. It is both electronically and ionically conductive, allowing for fast battery kinetics. The void space between the silicon particle and the carbon shell allows for the lithiated silicon to expand upon charging of the battery without breaking the carbon framework in the carbon shell.

Formation of SEI during initial cycling of a battery is unavoidable. A stable SEI layer can form and grow on the carbon shell to prevent the continual rupturing and reformation of SEI. The more uniform the surface, the more stably (and thinly) the SEI forms. Pinholes can develop in the carbon shell during formation and allow liquid electrolyte to reach the surface of the silicon particle inside the shell. The liquid electrolyte can be consumed at the surface of the silicon particle to create more SEI. Minor imperfections or pinholes in the carbon shell can “heal” from the formation of SEI, but this healing can consume a large amount of electrolyte and reduce coulombic efficiency and capacity of the battery. Generally, larger pinholes have a more significant impact on the coulombic efficiency loss.

Adding graphene flakes during the production of the anode can aid in covering the pinholes. Graphene is a two-dimensional (2-D) material with a high surface area and a high affinity to stick to scaffold surfaces. Pinholes in the shell can be patched with graphene flakes, leading to less electrolyte ingress, less loss of electrolyte and electroactive materials, less chance of electrolyte exhaustion or cell dry-out, and more efficiency. The geometry of the pinholes can naturally lock graphene sheets in the carbon scaffolding of the carbon shell. Excessive graphene sheets that do not bond to the scaffold pinholes can serve as active material for charge storage once coated onto the scaffolding of the carbon shell.

In some embodiments, the graphene flakes described herein can have properties the same or substantially similar to the graphene flakes described in U.S. Pat. 9,469,542 (the '542 patent”), filed Dec. 22, 2015 and titled “Large Scale Production of Thinned Graphite, Graphene, and Graphite-Graphene Composites,” the entire disclosure of which is hereby incorporated by reference.

As used herein, the term “crystalline graphite” or “precursor crystalline graphite” refers to graphite-based material of a crystalline structure with a size configured to allow ball milling in a ball milling jar. For example, the crystalline graphite can be layered graphene sheets with or without defects, such defects comprising vacancies, interstitials, line defects, etc. The crystalline graphite may come in diverse forms, such as but not limited to ordered graphite including natural crystalline graphite, pyrolytic graphite (e.g., highly ordered pyrolytic graphite (HOPG)), graphite fiber, graphite rods, graphite minerals, graphite powder, flake graphite, any graphitic material modified physically and/or chemically to be crystalline, and/or the like. As another example, the crystalline graphite can be graphite oxide.

As used herein, the term “thinned graphite” refers to crystalline graphite that has had its thickness reduced to a thickness from about a single layer of graphene to about 1,200 layers, which is roughly equivalent to about 400 nm. As such, single layer graphene sheets, few-layer graphene (FLG) sheets, and in general multi-layer graphene sheets with a number of layers about equal to or less than 1,200 graphene layers can be referred as thinned graphite.

As used herein, the term “few-layer graphene” (FLG) refers to crystalline graphite that has a thickness from about 1 graphene layer to about 10 graphene layers.

As used herein, the term “lateral size” or “lateral sheet size” relates to the in-plane linear dimension of a crystalline material. For example, the linear dimension can be a radius, diameters, width, length, diagonal, etc., if the in-plane shape of the material can be at least approximated as a regular geometrical object (e.g., circle, square, etc.). If the in-plane shape of the material can not be modeled by regular geometrical objects relatively accurately, the linear dimension can be expressed by characteristic parameters as is known in the art (e.g., by using shape or form factors).

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

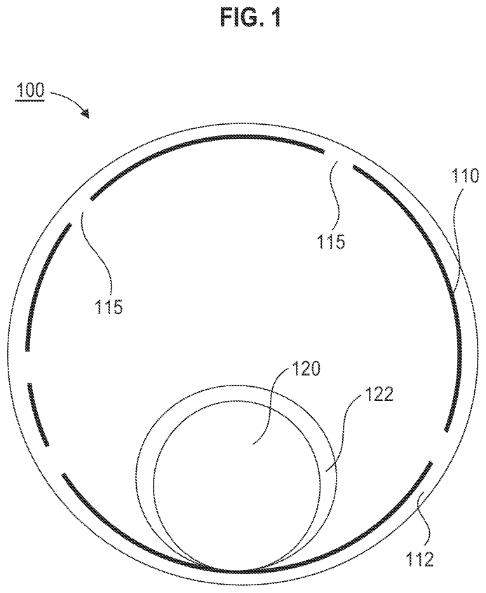

FIG. 1 shows formation of SEI layers on an anode 100 containing yolk-shell electroactive materials. As shown, the anode 100 includes a carbon shell 110 with an anode particle 120 disposed therein. The carbon shell 110 includes a plurality of pinholes 115 through which ingress of electrolyte can occur. As shown, a first SEI layer 112 is formed on the outside of the carbon shell 110 and a second SEI layer 122 is formed on the outside of the anode particle 120. The SEI layers 112, 122 can stabilize the operation of the anode 100, but they can also cause significant loss of active material and electrolyte as well as loss of coulombic efficiency. By covering the pinholes 115, electrolyte ingress into the carbon shell 110 can be substantially prevented, such that the second SEI layer 122 does not form around the outside of the anode particle 120, as shown in the embodiments described herein. Additionally, when expansion occurs with open pinholes 115 in the carbon shell 110, the carbon shell 120 and the SEI layer 122 can break, thereby forming new surfaces. Additional SEI layers can form on the new surfaces, leading to more lost electrolyte and electroactive species. This can occur in several initial cycles until the pinholes 115 are sealed.

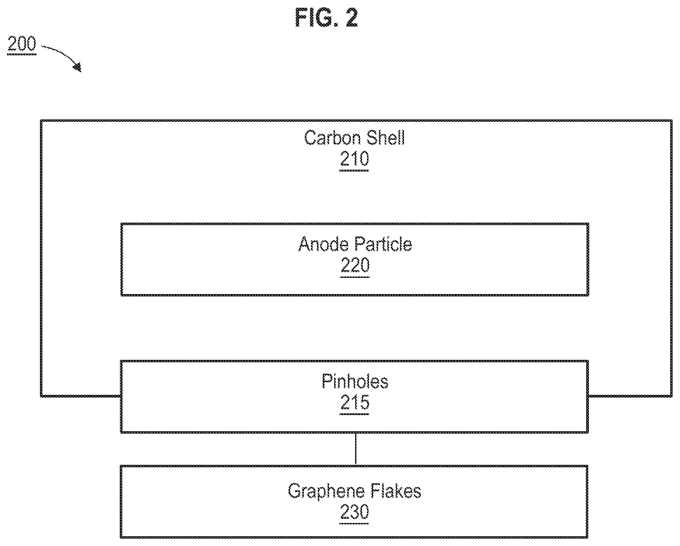

FIG. 2 is a block diagram of a graphene-patched anode 200 containing yolk-shell electroactive materials, according to an embodiment. As shown, the anode 200 includes a carbon shell 210 with pinholes 215, an anode particle 220 disposed in the carbon shell 210, and graphene flakes 230 covering the pinholes 215. In some embodiments, the carbon shell 210 can include amorphous carbon.

In some embodiments, the carbon shell 210 can be formed from tar. In some embodiments, the carbon shell 210 can be formed via chemical vapor deposition using a carbon-rich gas precursor. In some embodiments, the carbon shell 210 can be formed from carbon black. In some embodiments, the carbon shell 210 can be formed from activated charcoal. In some embodiments, the carbon shell 210 can be formed from depositing a carbon-rich liquid (e.g., carbon rich oils), a wax, and/or a polymer to the anode particle 220 while the anode particle 220 has a coating disposed thereon. The deposited material can then be burned at a temperature of less than about 400° C., less than about 350° C., less than about 300° C., less than about 250° C., or less than about 200° C., inclusive of all values and ranges therebetween. The burning of the deposited material can leave the carbon shell 210. In some embodiments, the carbon shell 210 can be formed from mixing conductive particles with water to form an aqueous slurry and spray-drying the water, leaving the conductive particles 220.

The pinholes 215 form during the production process of the anode 200. The pinholes 215 can be present in varying densities along the surface of the carbon shell 210. In some embodiments, the carbon shell 210 can include about 5, about 10, about 20, about 30, about 40, about 50, about 60, about 70, about 80, about 90, about 100, about 150, about 200, about 250, about 300, about 350, about 400, about 450, about 500, about 550, about 600, about 650, about 700, about 750, about 800, about 850, about 900, about 950, about 1,000, about 1,500, about 2,000, about 2,500, about 3,000, about 3,500, about 4,000, about 4,500, about 5,000, about 5,500, about 6,000, about 6,500, about 7,000, about 7,500, about 8,000, about 8,500, about 9,000, about 9,500, or about 10,000 pinholes 215, inclusive of all values and ranges therebetween. In some embodiments, the carbon shell 210 can include other imperfections, such as discontinuities, bumps, and multi-layered sections.

The anode particle 220 includes electroactive species. In some embodiments, the anode particle 220 can include silicon. In some embodiments, the anode particle 220 can include silicon alloys. In some embodiments, the anode particle 220 can include lithiated silicon or silicon alloys. The anode particle 220 can be bonded to an inner surface of the carbon shell 210. In some embodiments, the anode particle 220 can be bonded to the inner surface of the carbon shell 210 via van der Waals forces. In some embodiments, the anode particle 220 can be molecularly bonded to the inner surface of the carbon shell 210.

The graphene flakes 230 are coupled to the outside surface of the carbon shell 210 to cover the pinholes 215 and block ingress of electrolyte into the carbon shell 210. Graphene is a 2-D material with a very high surface area and a high affinity to stick to scaffold surfaces. The graphene flakes 230 can couple to the carbon scaffold via van der Waals forces. Excess graphene flakes 230 can coat the outer surface of the carbon shell 210 and act as active material and/or a conductive additive for charge storage. In some embodiments, the graphene flakes 230 can cover substantially all of the pinholes 220.

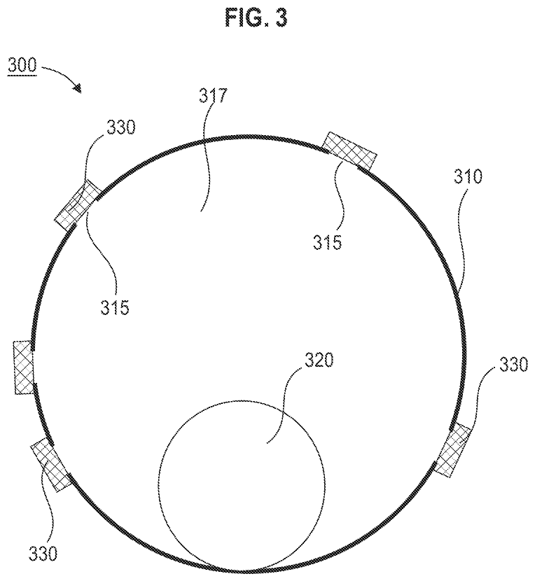

FIG. 3 shows an illustration of an anode 300, according to an embodiment. As shown, the anode 300 includes a carbon shell 310 with pinholes 315, an anode particle 320 disposed in the carbon shell 310, and graphene flakes 330 covering the pinholes 315. A void space 317 is shown inside the carbon shell 310. In some embodiments, the carbon shell 310, the pinholes 315, the anode particle 320, and the graphene flakes 330 can be the same or substantially similar to the carbon shell 210, the pinholes 215, the anode particle 220, and the graphene flakes 230, as described above with reference to FIG. 2. Thus, certain aspects of the carbon shell 310, the pinholes 315, the anode particle 320, and the graphene flakes 330 are not described in greater detail herein.

In some embodiments, the carbon shell 310 can be spherical or substantially spherical in shape. In some embodiments, the carbon shell 310 can be ellipsoidal in shape. In some embodiments, the carbon shell 310 can have a diameter of at least about 500 nm, at least about 600 nm, at least about 700 nm, at least about 800 nm, at least about 900 nm, at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, or at least about 900 μm. In some embodiments, the carbon shell 310 can have a diameter of no more than about 1 mm, no more than about 900 μm, no more than about 800 μm, no more than about 700 μm, no more than about 600 μm, no more than about 500 μm, no more than about 400 μm, no more than about 300 μm, no more than about 200 μm, no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm, no more than about 9 μm, no more than about 8 μm, no more than about 7 μm, no more than about 6 μm, no more than about 5 μm, no more than about 4 μm, no more than about 3 μm, no more than about 2 μm, no more than about 1 μm, no more than about 900 nm, no more than about 800 nm, no more than about 700 nm, or no more than about 600 nm.

Combinations of the above-referenced diameters of the carbon shell 310 are also possible (e.g., at least about 500 nm and no more than about 1 mm or at least about 50 μm and no more than about 500 μm), inclusive of all values and ranges therebetween. In some embodiments, the carbon shell 310 can have a diameter of about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, or about 1 mm.

In some embodiments, the carbon shell 310 can have a thickness (i.e., a wall thickness) of at least about 1 nm, at least about 2 nm, at least about 3 nm, at least about 4 nm, at least about 5 nm, at least about 6 nm, at least about 7 nm, at least about 8 nm, at least about 9 nm, at least about 10 nm, at least about 15 nm, at least about 20 nm, at least about 25 nm, at least about 30 nm, at least about 35 nm, at least about 40 nm, or at least about 45 nm. In some embodiments, the carbon shell 310 can have a thickness of no more than about 50 nm, no more than about 45 nm, no more than about 40 nm, no more than about 35 nm, no more than about 30 nm, no more than about 25 nm, no more than about 20 nm, no more than about 15 nm, no more than about 10 nm, no more than about 9 nm, no more than about 8 nm, no more than about 7 nm, no more than about 6 nm, no more than about 5 nm, no more than about 4 nm, no more than about 3 nm, or no more than about 2 nm. Combinations of the above-referenced wall thickness values of the carbon shell 310 are also possible (e.g., at least about 1 nm and no more than about 50 nm or at least about 3 nm and no more than about 20 nm), inclusive of all values and ranges therebetween. In some embodiments, the carbon shell 310 can have a thickness of about 1 nm, about 2 nm, about 3 nm, about 4 nm, about 5 nm, about 6 nm, about 7 nm, about 8 nm, about 9 nm, about 10 nm, about 15 nm, about 20 nm, about 25 nm, about 30 nm, about 35 nm, about 40 nm, about 45 nm, or about 50 nm.

In some embodiments, the pinholes 315 can have a width (e.g., a diameter) of at least about 50 nm, at least about 100 nm, at least about 200 nm, at least about 300 nm, at least about 400 nm, at least about 500 nm, at least about 600 nm, at least about 700 nm, at least about 800 nm, at least about 900 nm, at least about 1 μm, at least about 1.1 μm, at least about 1.2 μm, at least about 1.3 μm, or at least about 1.4 μm. In some embodiments, the pinholes 315 can have a width of no more than about 1.5 μm, no more than about 1.4 μm, no more than about 1.3 μm, no more than about 1.2 μm, no more than about 1.1 μm, no more than about 1 μm, no more than about 900 nm, no more than about 800 nm, no more than about 700 nm, no more than about 600 nm, no more than about 500 nm, no more than about 400 nm, no more than about 300 nm, no more than about 200 nm, or no more than about 100 nm. In some embodiments, the pinholes 315 can have a width of about 50 nm, about 100 nm, about 200 nm, about 300 nm, about 400 nm, about 500 nm, about 600 nm, about 700 nm, about 800 nm, about 900 nm, about 1 μm, about 1.1 μm, about 1.2 μm, about 1.3 μm, about 1.4 μm, or about 1.5 μm.

The void space 317 between the anode particle 320 and the carbon shell 310 can allow for the expansion of the anode particle 320. For example, if the anode particle 320 is composed of lithiated silicon, the lithiated silicon can expand upon charging of the battery without breaking the carbon framework of the carbon shell 310. In some embodiments, the void space 317 can occupy at least about 20%, at least about 30%, at least about 40%, at least about 50%, at least about 60%, at least about 70%, at least about 80%, at least about 90%, at least about 95%, at least about 96%, at least about 97%, at least about 98%, or at least about 99% of the inner volume of the carbon shell 310. In some embodiments, the void space 317 can occupy no more than about 99%, no more than about 98%, no more than about 97%, no more than about 96%, no more than about 95%, no more than about 90%, no more than about 80%, no more than about 70%, no more than about 60%, no more than about 50%, no more than about 40%, or no more than about 30%. Combinations of the above-referenced volume percentages of the void space 317 are also possible (e.g., at least about 20% and no more than about 99% or at least about 40% and no more than about 80%), inclusive of all values and ranges therebetween. In some embodiments, the void space 317 can occupy about 20%, about 30%, about 40%, about 50%, about 60%, about 70%, about 80%, about 90%, about 95%, about 96%, about 97%, about 98%, or about 99% of the inner volume of the carbon shell 310.

As shown, the anode 300 includes one anode particle 320. In some embodiments, the anode 300 can include 2, 3, 4, 5, 6, 7, 8, 9, 10, or at least about 10 anode particles 320, inclusive of all values and ranges therebetween. In some embodiments, the anode particle 320 can be spherical or substantially spherical in shape. In some embodiments, the anode particle 320 can be ellipsoidal in shape. In some embodiments, the anode particle 320 can have a width (e.g., a diameter) of at least about 200 nm, at least about 300 nm, at least about 400 nm, at least about 500 nm, at least about 600 nm, at least about 700 nm, at least about 800 nm, at least about 900 nm, at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 20 μm, at least about 30 μm, at least about 40 μm, at least about 50 μm, at least about 60 μm, at least about 70 μm, at least about 80 μm, or at least about 90 μm. In some embodiments, the anode particle 320 can have a width of no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm, no more than about 9 μm, no more than about 8 μm, no more than about 7 μm, no more than about 6 μm, no more than about 5 μm, no more than about 4 μm, no more than about 3 μm, no more than about 2 μm, no more than about 1 μm, no more than about 900 nm, no more than about 800 nm, no more than about 700 nm, no more than about 600 nm, no more than about 500 nm, no more than about 400 nm, or no more than about 300 nm. Combinations of the above-referenced widths of the anode particle 320 are also possible (e.g., at least about 200 nm and no more than about 100 μm or at least about 500 nm and no more than about 10 μm), inclusive of all values and ranges therebetween. In some embodiments, the anode particle 320 can have a width (e.g., a diameter) of about 200 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about 70 μm, about 80 μm, about 90 μm, or about 100 μm.

In some embodiments, the graphene flakes 330 can have any of the physical properties of the graphene flakes described in the '542 patent. In some embodiments, the graphene flakes 330 can have a lateral dimension of at least about 10 nm, at least about 50 nm, at least about 100 nm, at least about 500 nm, at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 110 μm, at least about 120 μm, at least about 130 μm, or at least about 140 μm. In some embodiments, the graphene flakes 330 can have a lateral dimension of no more than about 150 μm, no more than about 140 μm, no more than about 130 μm, no more than about 120 μm, no more than about 110 μm, no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm, no more than about 5 μm, no more than about 1 μm, no more than about 500 nm, no more than about 100 nm, or no more than about 50 nm. Combinations of the above-referenced lateral dimensions of the graphene flakes 330 are also possible (e.g., at least about 10 nm and no more than about 150 μm or at least about 10 μm and no more than about 100 μm), inclusive of all values and ranges therebetween. In some embodiments, the graphene flakes 330 can have a lateral dimension of about 10 nm, about 50 nm, about 100 nm, about 500 nm, about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about 70 μm, about 80 μm, about 90 μm, about 100 μm, about 110 μm, about 120 μm, about 130 μm, about 140 μm, or about 150 μm.

In some embodiments, the graphene flakes 330 can have a thickness of at least about 1 graphene layer, at least about 2 graphene layers, at least about 3 graphene layers, at least about 4 graphene layers, at least about 5 graphene layers, at least about 6 graphene layers, at least about 7 graphene layers, at least about 8 graphene layers, at least about 9 graphene layers, at least about 10 graphene layers, at least about 11 graphene layers, at least about 12 graphene layers, at least about 13 graphene layers, at least about 14 graphene layers, at least about 15 graphene layers, at least about 16 graphene layers, at least about 17 graphene layers, at least about 18 graphene layers, or at least about 19 graphene layers. In some embodiments, the graphene flakes 330 can have a thickness of no more than about 20 graphene layers, no more than about 19 graphene layers, no more than about 18 graphene layers, no more than about 17 graphene layers, no more than about 16 graphene layers, no more than about 15 graphene layers, no more than about 14 graphene layers, no more than about 13 graphene layers, no more than about 12 graphene layers, no more than about 11 graphene layers, no more than about 10 graphene layers, no more than about 9 graphene layers, no more than about 8 graphene layers, no more than about 7 graphene layers, no more than about 6 graphene layers, no more than about 5 graphene layers, no more than about 4 graphene layers, no more than about 3 graphene layers, or no more than about 2 graphene layers. Combinations of the above-referenced thicknesses of the graphene flakes 330 are also possible (e.g., at least about 1 graphene layer and no more than about 20 graphene layers or at least about 5 graphene layers and no more than about 10 graphene layers), inclusive of all values and ranges therebetween. In some embodiments, the graphene flakes 330 can have a thickness of about 1 graphene layer, about 2 graphene layers, about 3 graphene layers, about 4 graphene layers, about 5 graphene layers, about 6 graphene layers, about 7 graphene layers, about 8 graphene layers, about 9 graphene layers, about 10 graphene layers, about 11 graphene layers, about 12 graphene layers, about 13 graphene layers, about 14 graphene layers, about 15 graphene layers, about 16 graphene layers, about 17 graphene layers, about 18 graphene layers, about 19 graphene layers, or about 20 graphene layers.

In some embodiments, the graphene flakes 330 can have an aspect ratio of at least about 50, at least about 100, at least about 500, at least about 1,000, at least about 5,000, at least about 10,000, at least about 20,000, at least about 30,000, or at least about 40,000. In some embodiments, the graphene flakes 330 can have an aspect ratio of no more than about 50,000, no more than about 40,000, no more than about 30,000, no more than about 20,000, no more than about 10,000, no more than about 5,000, no more than about 1,000, no more than about 500, or no more than about 100. Combinations of the above-referenced aspect ratios are also possible (e.g., at least about 50 and no more than about 50,000 or at least about 500 and no more than about 5,000), inclusive of all values and ranges therebetween. In some embodiments, the graphene flakes 330 can have an aspect ratio of about 50, about 100, about 500, about 1,000, about 5,000, about 10,000, about 20,000, about 30,000, about 40,000, or about 50,000.

As shown, the graphene sheets 330 cover all of the pinholes 315. In some embodiments, the graphene sheets 330 can cover at least about 50%, at least about 55%, at least about 60%, at least about 65%, at least about 70%, at least about 75%, at least about 80%, at least about 85%, at least about 90%, at least about 95%, at least about 96%, at least about 97%, at least about 98%, at least about 99%, or about 100% of the pinholes 315, inclusive of all values and ranges therebetween. The geometry of the pinholes 315 can naturally lock the graphene sheets 330 into the carbon scaffold of the carbon shell 310. In some embodiments, the graphene sheets 330 can have a thickness similar to the wall thickness of the carbon shell 310. In some embodiments, the ratio of the thickness of the graphene sheets 330 to the thickness of the carbon shell 310 can be about 0.1, about 0.2, about 0.3, about 0.4, about 0.5, about 0.6, about 0.7, about 0.8, about 0.9, about 1.0, about 1.1, about 1.2, about 1.3, about 1.4, about 1.5, about 1.6, about 1.7, about 1.8, about 1.9, about 2.0, about 2.5, about 3.0, about 3.5, about 4.0, about 4.5, about 5.0, about 5.5, about 6.0, about 6.5, about 7.0, about 7.5, about 8.0, about 8.5, about 9.0, about 9.5, or about 10.0, inclusive of all values and ranges therebetween. In some embodiments, excess graphene sheets 330 can couple to the outside of the carbon shell 310 and serve as active material for charge storage once coated as part of the anode 300.

In some embodiments, multiple anodes 300 can be co-suspended in a solvent to form an anode slurry. In some embodiments, the solvent can include water. In some embodiments, the solvent can include N-methyl-2-pyrrolidone (NMP). In some embodiments, the anode slurry can include a binder. The binder can bind multiple anodes 300 together. In some embodiments, the binder can include carboxymethyl cellulose (CMC), styrene-butadiene rubber (SBR), polyacrylic acid (PAA), or any combination thereof.

In some embodiments, a plurality of carbon shells 310 can be suspended in a solvent to form an anode slurry. In some embodiments, at least about 50%, at least about 60%, at least about 70%, at least about 80%, at least about 90%, at least about 91%, at least about 92%, at least about 93%, at least about 94%, at least about 95%, at least about 96%, at least about 97%, at least about 98%, at least about 99%, at least about 99.1%, at least about 99.2%, at least about 99.3%, at least about 99.4%, at least about 99.5%, at least about 99.6%, at least about 99.7%, at least about 99.8%, or at least about 99.9% of the carbon shells 310 can include anode particles 320 disposed therein. In some embodiments, at least about 50%, at least about 60%, at least about 70%, at least about 80%, at least about 90%, at least about 91%, at least about 92%, at least about 93%, at least about 94%, at least about 95%, at least about 96%, at least about 97%, at least about 98%, at least about 99%, at least about 99.1%, at least about 99.2%, at least about 99.3%, at least about 99.4%, at least about 99.5%, at least about 99.6%, at least about 99.7%, at least about 99.8%, or at least about 99.9%, of the carbon shells 310 can include at least one pinhole 315.

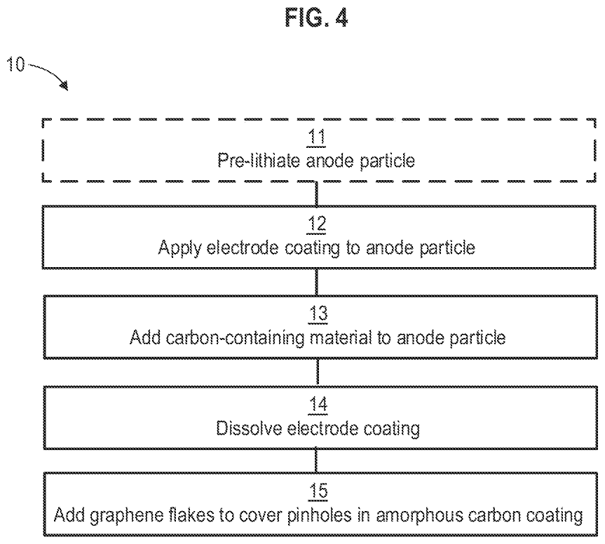

FIG. 4 shows a block diagram of a method 10 of producing a graphene-patched anode containing yolk-shell electroactive materials, according to an embodiment. As shown, the method 10 optionally includes pre-lithiating an anode particle at step 11. The method 10 further includes applying an electrode coating to the anode particle at step 12, adding a carbon-containing material to the anode particle at step 13, dissolving the electrode coating at step 14, and adding graphene flakes to cover pinholes in the amorphous carbon coating at step 15.

Lithiating the anode particle at step 11 is optional and can reduce the amount of active material and electrode consumed during SEI formation. Lithium is applied to the anode particle in the form of a lithium-containing material. In some embodiments, the lithium-containing material can include lithium metal, lithium cobalt oxide, lithium iron phosphate, lithium manganese oxide, lithium nickel manganese cobalt oxide, or any other suitable lithium-containing material or combinations thereof. In some embodiments, lithiation can occur via mixing the lithium-containing material with a plurality of anode particles. This mixing can occur in a solvent.

Step 12 includes application of an electrode coating to the anode particle. The electrode coating can function as a sacrificial coating, in that it can dissolve or otherwise dissipate during the production of the electrode. In some embodiments, the electrode coating can include silicon dioxide. In some embodiments, the electrode coating can be dissolved in a solvent. In some embodiments, step 12 can include mixing a plurality of anode particles with the electrode coating. In some embodiments, the electrode coating can include a gel. In some embodiments, the addition of the electrode coating can increase the diameter of the anode particle by a factor of at least about 1.1, at least about 1.2, at least about 1.3, at least about 1.4, at least about 1.5, at least about 1.6, at least about 1.7, at least about 1.8, at least about 1.9, at least about 2, at least about 2.5, at least about 3, at least about 3.5, at least about 4, at least about 4.5, at least about 5, at least about 5.5, at least about 6, at least about 6.5, at least about 7, at least about 7.5, at least about 8, at least about 8.5, at least about 9, at least about 9.5, at least about 10, at least about 15, at least about 20, at least about 25, at least about 30, at least about 35, at least about 40, or at least about 45. In some embodiments, the addition of the electrode coating can increase the diameter of the anode particle by a factor of no more than about 50, no more than about 45, no more than about 40, no more than about 35, no more than about 30, no more than about 25, no more than about 20, no more than about 15, no more than about 10, no more than about 9, no more than about 8.5, no more than about 8, no more than about 7.5, no more than about 7, no more than about 6.5, no more than about 6, no more than about 5.5, no more than about 5, no more than about 4.5, no more than about 4, no more than about 3.5, no more than about 3, no more than about 2.5, no more than about 2, no more than about 1.9, no more than about 1.8, no more than about 1.7, no more than about 1.6, no more than about 1.5, no more than about 1.4, no more than about 1.3, or no more than about 1.2.

Combinations of the above-referenced diameter expansion factors are also possible (e.g., at least about 1.1 and no more than about 50 or at least about 2 and no more than about 10), inclusive of all values and ranges therebetween. In some embodiments, the addition of the electrode coating can increase the diameter of the anode particle by a factor of about 1.1, about 1.2, about 1.3, about 1.4, about 1.5, about 1.6, about 1.7, about 1.8, about 1.9, about 2, about 2.5, about 3, about 3.5, about 4, about 4.5, about 5, about 5.5, about 6, about 6.5, about 7, about 7.5, about 8, about 8.5, about 9, about 9.5, about 10, about 15, about 20, about 25, about 30, about 35, about 40, about 45, or about 50.

The method 10 further includes adding a carbon-containing material to the anode particle at step 13. In some embodiments, the carbon-containing material can be dissolved and/or suspended in a solvent. In some embodiments, the carbon-containing material can be added to the anode particle via a liquid tar coating. In some embodiments, the carbon-containing material can include amorphous carbon. In some embodiments, the liquid tar coating can be heated to leave an amorphous carbon coating on the anode particle. In some embodiments, the carbon-containing material can be applied to the anode via chemical vapor deposition (CVD). In some embodiments, the carbon-containing material can include activated charcoal. In some embodiments, the carbon-containing material can include carbon black. In some embodiments, the carbon can be in a suspension when it is added to the anode particle. In some embodiments, the suspension can include water, N-methyl pyrrolidone (NMP), dimethyl carbonate (DMC), ethylene carbonate (EC), diethyl carbonate (DEC), ethyl methyl carbonate (EMC), or any other suitable non-aqueous solvent or combinations thereof In some embodiments, the suspension can be a slurry. In some embodiments, the slurry can include a binder. In some embodiments, the binder can include polyvinylidene fluoride (PVDF). In some embodiments, the binder can include polyvinylidene chloride (PVDC). The carbon-containing material forms a carbon shell around the outside of the anode particle.

Step 14 includes dissolving the electrode coating. Dissolving the electrode coating leaves the anode particle in the carbon shell with a void space. In some embodiments, the dissolving can be via an acid wash. In some embodiments, the acid wash can include nitric acid. In some embodiments, the acid wash can include hydrofluoric acid. In some embodiments, the acid wash can dissolve substantially all of the electrode coating to leave the void space in the carbon shell.

The method 10 further includes adding graphene flakes to cover pinholes in the carbon shell at step 15. In some embodiments, the graphene flakes can be added directly to the suspension that includes the electrode coating. In some embodiments, the graphene flakes can be added to the suspension prior to mixing the suspension and the anode particles. In some embodiments, the graphene flakes can be added to the suspension after mixing the suspension with the anode particles.

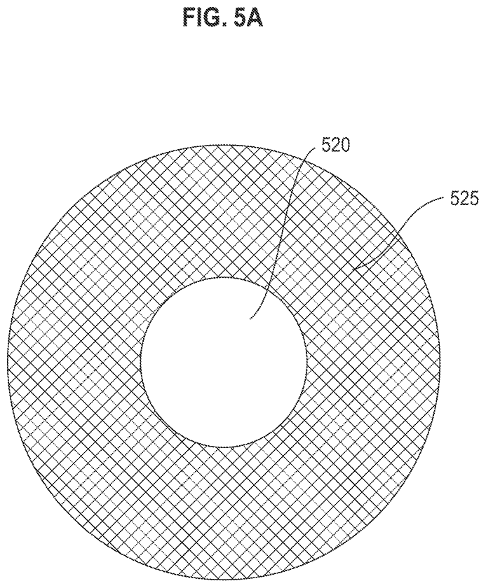

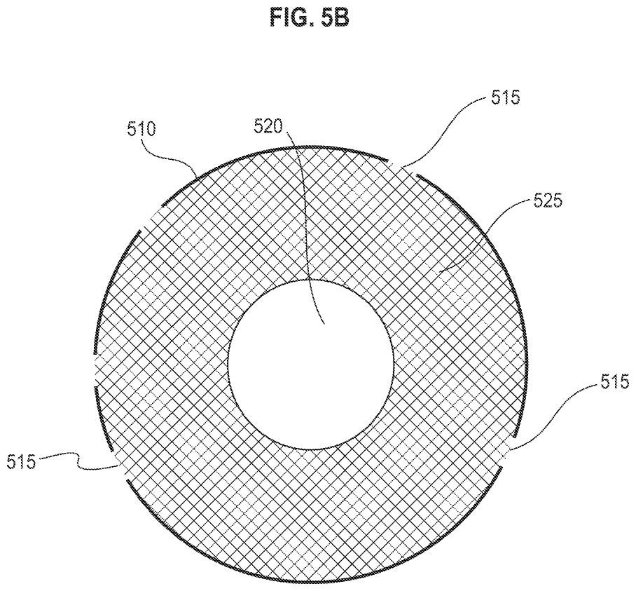

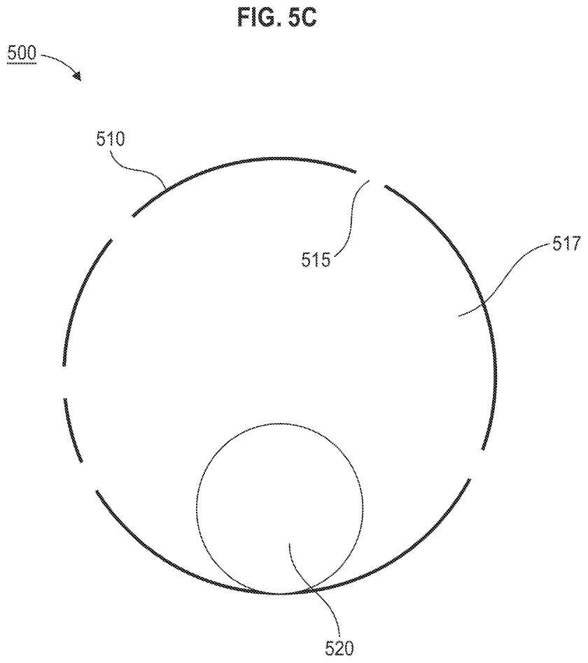

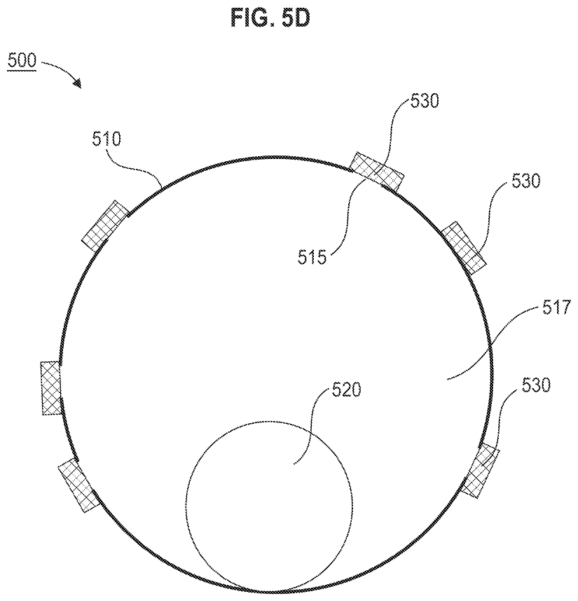

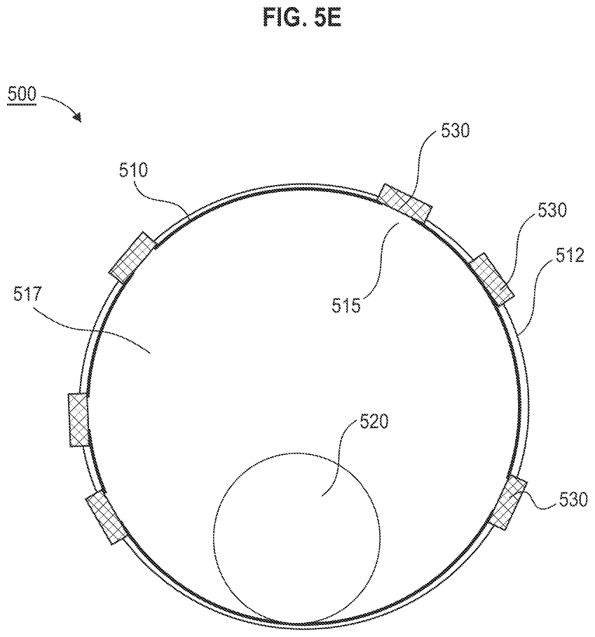

FIGS. 5A-5E illustrate a method of producing a graphene-patched anode containing yolk-shell electroactive materials, according to an embodiment. FIG. 5A shows an anode particle 520 covered with an electrode coating 525. In some embodiments, the electrode coating 525 can be held to the anode particle 520 via surface tension. In some embodiments, the electrode coating 525 can include an oxidized layer (e.g., SiO₂ disposed around a silicon particle). In some embodiments, the electrode coating 525 can be in the form of a gel. In some embodiments, the electrode coating 525 can include a material that can be selectively etched. In some embodiments, the electrode coating 525 can include silicon dioxide, aluminum, indium tin oxide, chromium, gallium arsenide, gold, molybdenum, platinum, silicon, silicon nitride, polystyrene, tantalum, titanium, titanium nitride, tungsten, or any combination thereof.

FIG. 5B shows a carbon shell 510 forming around the outside of the electrode coating 525. The carbon shell 510 includes pinholes 515. The carbon shell 510 can be formed from addition of a suspension to the anode particle 520. In some embodiments, the suspension can include amorphous carbon. In some embodiments, the suspension can include carbon black. In some embodiments, the carbon shell 510 can be formed from addition of a liquid tar coating, a carbon-rich oil, a polymer, and/or a wax. In some embodiments, the carbon shell 510 can be formed via CVD coating. FIG. 5C shows the dissolution of the electrode coating 525 to leave a void space 517, such that the anode particle 520 falls to contact the carbon shell 510. The void space 517 can allow for expansion of the anode particle 520 during cycling.

FIG. 5D shows addition of graphene flakes 530 to cover the pinholes 515. As shown, some of the graphene flakes 530 cover the pinholes 515 while some of the graphene flakes 530 bond to the exterior surface of the carbon shell 510. FIG. 5E shows formation of the SEI 512 during cycling. As shown, the SEI 512 is less prominent than the SEI's 112, 122 formed on the anode 100, as described above with reference to FIG. 1. Because the graphene flakes 530 have substantially prevented ingress of electrolyte into the carbon shell 510, little or no SEI has formed directly on the outer surface of the anode particle 520. The graphene flakes 530 make the outer surface relatively smooth and reduce the overall number of discontinuities on the outer surface of the graphene flakes 530. This can aid in avoiding excessive growth of the SEI 512, compared to a surface with more discontinuities or larger discontinuities. The thinner SEI 512 leads to less electrolyte loss and less loss of electroactive species during cycling.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An anode, comprising:
a carbon shell having an outer surface and an inner volume, the carbon shell including a plurality of pinholes on the outer surface;
an anode particle disposed in the inner volume of the carbon shell, such that a portion of the inner volume includes void space; and
a plurality of graphene flakes disposed on the outer surface of the carbon shell, the plurality of graphene flakes covering at least a portion of the pinholes.

2. The anode of claim 1, wherein at least about 50% of the inner volume of the carbon shell includes void space.

3. The anode of claim 1, wherein the plurality of graphene flakes cover at least 90% of the pinholes.

4. The anode of claim 1, wherein the plurality of graphene flakes have a thickness of less than about 10 graphene layers.

5. The anode of claim 1, wherein the anode particle includes silicon.

6. The anode of claim 5, wherein the silicon is lithiated.

7. The anode of claim 1, wherein the carbon shell is an amorphous carbon shell.

8. The anode of claim 1, wherein the plurality of graphene flakes have a thickness between about 0.1 and about 10 times a thickness of walls of the carbon shell.

9. The anode of claim 1, wherein at least a portion of the graphene flakes are coupled to the outer surface of the carbon shell.

10. A method, comprising:
applying a sacrificial coating to an anode particle to form a coated anode particle;
adding an amorphous carbon to the coated anode particle to form a particle with an amorphous carbon shell, the amorphous carbon shell including a plurality of pinholes, the particle with the amorphous carbons shell suspended in a liquid;
dissolving the sacrificial coating to form an electrode with void space suspended in a slurry; and
adding a plurality of graphene particles to the slurry such that the plurality of graphene particles cover at least a portion of the plurality of pinholes.

11. The method of claim 10, wherein at least a portion of the plurality of graphene particles bond to portions of the amorphous carbon coating without pinholes.

12. The method of claim 10, wherein the plurality of graphene particles is a first plurality of graphene particles, the method further comprising:
adding a second plurality of graphene particles to the amorphous carbon coating.

13. The method of claim 10, wherein the sacrificial coating includes silicon dioxide.

14. The method of claim 10, wherein the anode particle includes lithiated silicon.

15. The method of claim 10, wherein the dissolving is via an acid wash.

16. The method of claim 10, wherein the amorphous carbon is suspended in water.

17. The method of claim 10, wherein the amorphous carbon coating is formed from at least one of a liquid tar coating, a carbon-rich oil, a polymer, or a wax.

18. The method of claim 17, wherein the liquid tar coating, the carbon-rich oil, the polymer, and/or the wax is heated to leave the amorphous carbon on the electrode.

19. The method of claim 10, wherein adding the amorphous carbon coating is via CVD.

20. A composition, comprising:
a plurality of carbon shells suspended in a solvent, at least about 80% of the carbon shells including a pinhole;
a plurality of anode particles suspended in the solvent, such that at least about 80% of the carbon shells has an anode particle disposed therein;
a plurality of graphene flakes disposed in the solvent such that the plurality of graphene flakes cover at least about 80% of the pinholes on the carbon shells.

21. The composition of claim 20, wherein at least about 90% of the carbon shells include a pinhole, at least about 90% of the carbon shells have an anode particle disposed therein, and the plurality of graphene flakes cover at least about 90% of the pinholes.

22. The composition of claim 20, wherein the plurality of graphene flakes cover at least about 99% of the pinholes.

23. The composition of claim 20, wherein the plurality of graphene flakes have an average thickness of no more than about 5 graphene layers.
